(19) United States
(12) Patent Application Publication
(10) Pub. No.: US 2012/0324118 A1
(43) Pub. Date: Dec. 20, 2012

(54) SYSTEM AND METHOD FOR FACILITATING TECHNICAL SUPPORT

(75) Inventors: Thomas Pfleider, Beaumont, CA (US); Glenn A. Mills, Danville, CA (US)

(73) Assignee: SPOT ON SERVICES, INC., Orange, CA (US)

(21) Appl. No.: 13/517,510

(22) Filed: Jun. 13, 2012

Related U.S. Application Data
(60) Provisional application No. 61/497,009, filed on Jun. 14, 2011.

(51) Int. Cl. G06F 15/16

(52) U.S. Cl. 709/227

(57) ABSTRACT

A system and method are disclosed for facilitating technical support of equipment at multiple different geographic equipment locations such as hospitals and others, by a number of different vendors or manufacturers at still different geographic locations. Service calls are completed by means of a central portal which establishes an electronic communication path between portable computer customer support devices and manufacturer support devices. Soft buttons on the customer support devices may be selectively activated individually to call the central portal which then completes the establishment of communication between portable computer customer support devices and selected manufacturer support devices.

### RELATED APPLICATION

This application claims priority to U.S. provisional patent application Ser. No. 61/497,009, filed Jun. 14, 2011, and is incorporated herein by reference in its entirety as if fully set forth herein.

### FIELD OF THE INVENTION

The present invention relates in general to a system and method for facilitating technical support. It more particularly relates to such a system and method for monitoring and supporting remote equipment such as the equipment used in hospitals and other businesses.

### BACKGROUND ART

This section describes the background art of the disclosed embodiment of the present invention. There is no intention, either express or implied, that the background art discussed in this section legally constitutes prior art.

Many manufacturers and vendors of equipment provide remote technical support for their products via phone or perhaps a digital link to their equipment. But not in the same manner described herein. There can be the use of instant messaging, text typing, video calls and chats conducted over the Internet.

While these techniques may be satisfactory for some applications, other applications where, for example, time is of the essence, it may be difficult to use the prior known techniques to solve urgent equipment issues related to user familiarity with equipment, user issues or malfunctions or other problems in a satisfactory highly efficient manner. For example, when surgery is performed in the hospital, an equipment malfunction must be addressed immediately or at least in a highly efficient rapid manner, since time is of the essence and may even be a life or death situation. To find and make a call to a technician and then have the technician either travel to the hospital or have the technician provide a solution over the telephone, can be time consuming and a daunting task in certain situations and often impeded by language barriers and communication difficulty in describing the issue, equipment, etc.

Another problem that manufacturers and vendors of equipment for hospitals and other businesses may have, relates to distributing company or product information to all of the users, such as operating room personnel or surgeons, of their equipment when a new product is released or an existing product is recalled. Currently, for this purpose, advertisements may be placed in magazines, websites may communicate this information, and/or representatives may be used to contact the hospitals or businesses. All of these techniques may be, and often times are, less than satisfactory in so far as they may not be successful in alerting in a timely manner the decision makers or other responsible individuals in taking the requested or desired actions.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1. is a diagrammatic view of a support facilitating system, which is constructed in accordance with an embodiment of the present invention;

FIG. 2 is a screen shot of a portable computer customer service device, Including but not limited to a computer workstation, computer tablet, smart phone, which illustrates certain soft buttons for accessing vendor product education and reference materials and initiating an immediate visual interface with vendors/manufacturers support personnel, illustrating a home page screen;

FIG. 3 is a layout drawing of various features of the system of FIG. 1;

FIGS. 4 and 5 are other enlarged screen shots similar to FIG. 2;

FIG. 6 is a further screen shot similar to FIG. 2; and

FIGS. 7 and 8 are face views of the customer service device of FIG. 2, illustrating it in the process of being used to conduct a video call for technical support.

### CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of certain ones of the embodiments of the system, components and method of the present invention, as represented in the drawings, is not intended to limit the scope of the invention, as claimed, but is merely representative of the embodiment of the invention.

According to certain embodiments of the invention, a system and method are disclosed for facilitating technical support of equipment at multiple different geographic equipment locations such as hospitals and others, by a number of different vendors or manufacturers at still different geographic locations. Service calls are completed by means of a central portal which establishes an electronic communication path between portable computer customer support devices and manufacturer support devices. Soft buttons on the customer support devices may be selectively activated individually to call the central portal which then completes the establishment of communication between portable computer customer support devices and selected manufacturer support devices.

The system and method embodiments disclosed herein differentiate this electronic communication by being able to initiate a call from a wi-fi signal and connecting to a device with a wi-fi or cellular signal. An essential feature to ensure a direct video interface in every instance. This capability is further enhanced since the outbound call, from the operating room in this instance, may currently be directed to up to 4 people at different locations simultaneously with all receiving parties aware of which called parties are involved in the customer call. Furthermore, one or all of the summoned parties may connect visually with the calling party. The call can only be initiated from the customer support device while all MFT support personnel can only receive such calls.

According to other embodiments of the present invention, the system and method also facilitate enabling the manufacturers/vendors to distribute messages to the customer support devices directly. In this manner, product updates, product recalls and a variety of other such messages can be quickly and conveniently sent to the users or other responsible individuals.

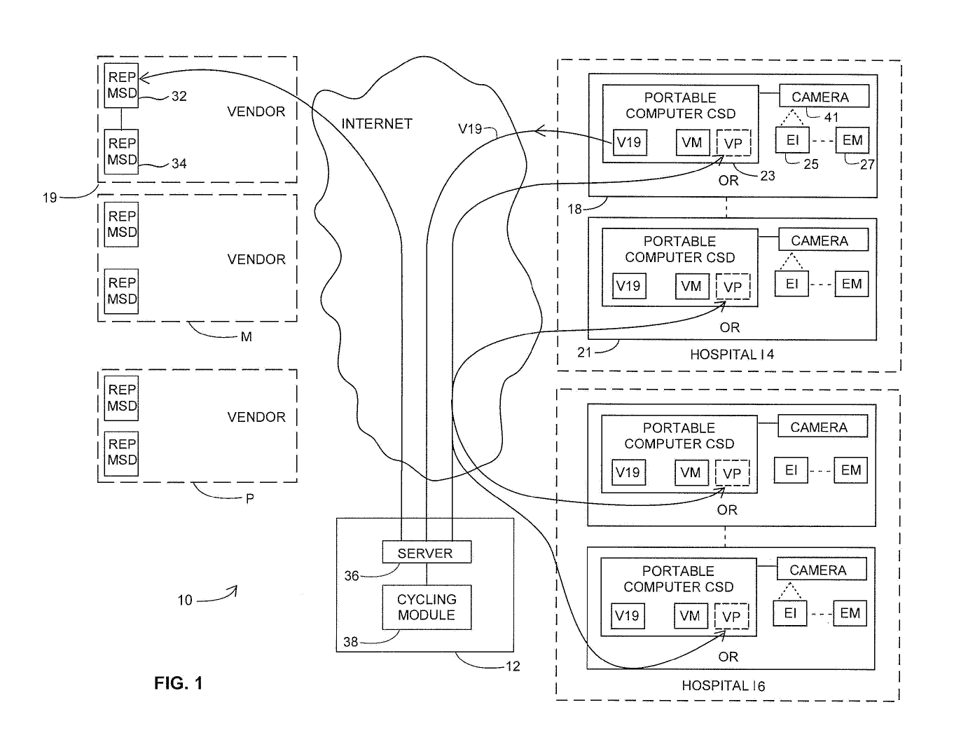

Referring now to FIG. 1 of the drawings, there is shown a system 10, which is constructed in accordance with an embodiment of the invention and which includes a central spot on service portal 12 for communicating with different entities such as a hospital 14 and a hospital 16. The entities may include different departments such as operating rooms 18 and 21. It should be understood that the presently preferred embodiment of the present invention is for use in hospitals and hospital operating rooms or surgery centers. However, it should also be understood that the system and method of the present invention are contemplated for use in many other environments and businesses. For illustration purposes only and not as a limitation in the scope of the invention, the present embodiments of the invention are described herein in connection with the hospital environment.

Each operating room such as the operating room 18 may employ one or more portable computer customer support device such as the device 23. The customer support device 23 may be in the form of a laptop computer, a desktop computer, a notebook computer, a tablet computer or other portable computer such as a smart phone. The presently preferred customer support device is an Apple iPad2 tablet computer. When a customer issue occurs, for example, in one of the operating room equipment such as equipment 25 and equipment 27 disposed in the operating room 18, the customer support device 23 can establish an electronic communication path directly and quickly to a representative of the vendors or manufacturer of the malfunctioning equipment, to provide technical support, as hereinafter described in greater detail.

The inventive technique may provide the ability to access product information for all contracted vendors (in advance of a video interface).

A group of vendor/manufacturer (MFT) entities such as vendor 19 and other vendors such as vendor M, may be located at different geographic locations separate from the hospitals such as hospitals 14 and 16 having the equipment supplied by the vendors such as vendor 19. Each vendor such as the vendor 19 may employ one or more representative manufacturer support devices such as the devices 32 and 34. These devices such as the representative manufacturer support device 32 may be employed by representatives or other support personnel of the vendor to communicate with a user of one of the portable computer customer support devices such as the device 23.

Considering now the central portal 12 in greater detail, the portal 12 includes a server 36 to communicate with the customer service devices such as the device 23 and also with the representative manufacturer support devices such as the device 32 over a suitable network such as the Internet. In this manner, the central portal 12 serves as a gateway for access to digital content provided for user assistance and support and to complete the electronic establishment of communications between the operating room customer service devices and the vendor customer service, direct representative, distributors or assigned technical liaisons for the manufacturer support devices. Thus, substantially all communications between the portable devices serving as customer service devices such as the device 23, and all of the vendor representative manufacturer support devices such as the device 32 are established through the portal 12. This portal 12 is also the central hub for all vendor content that is supplied to the OR support device as well as the customer service, representative and distributor application (app).

The portal 12 includes a smart dialing software with an approved caller/recipient data base module 38 which enables the portal 12 to find the first available representative manufacturer support device such as the device 32 when a call is to be initiated from one of the customer service devices such as the device 23. This verbal or visual interface create a singular visual interface for each hospital support device with a chosen vendor which has particular assigned parties for the hospital device. The call may be received as verbal only. Interface is HIPAA compliant, encrypted, verified (as to approved party to accept call).

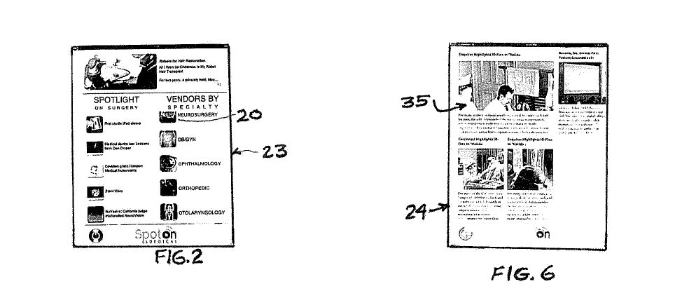

Considering now in greater detail the portable computer customer support devices with reference to FIGS. 1 and 2, the device 23 employs a series of soft buttons such as the soft buttons V19 and VM which correspond to the vendor 19 and the vendor M respectively. In this regard, the soft button V19 may be activated selectively by the user to call the central portal 12 to complete the establishment of an electronic communication between the customer support device V19 and the selected vendor 19. The routing module 38 of the portal 12 determines the first available manufacturer assigned personnel that are responsible for responding to the customer support call, such as device 32.

When a new vendor such as a vendor P becomes associated with the system 10, the portal 12 uploads information to each one of the customer service devices such as the device 23 to create a new soft button such as VP. In this manner, the hospitals will then have immediate access to the new vendor. It should be understood that only those customer service devices associated with products supplied by the new vendor will receive the new soft button. Vendors will have complete ability to control the appearance, content and order of the material presented within the boundaries of the software template. All SpotOn support devices in the operating room may have identical content from all of the contracted vendors for SpotOn.

A video camera 41 associated with the portable computer customer service device 23 enables the equipment such as the equipment 25 to be captured on a motion picture video is so that in the present example the user of the customer service device 23 can have a video conference such as a Face Time conference with the representative using the representative manufacturer support device 32 to facilitate instructing the user of the equipment 25 for correcting malfunctions or for other reasons to assist the user. It should be understood that the scope of the present invention is not limited to the use of video conferencing or video cameras since other forms of communication such as voice communication may also be available. Some vendor/manufacturers provide fixed cameras for the OR to view what is going on in the room. These options do not give the ability to walk the camera around the room to provide a close up or perhaps view the back of a piece of equipment that is hidden from the view of a wall mounted camera with a macro view. The device 23 provides a macro, micro and portable view with the additional ability of capturing and sending a picture as well as dynamic zoom/shrink capability to provide magnified views of important detail.

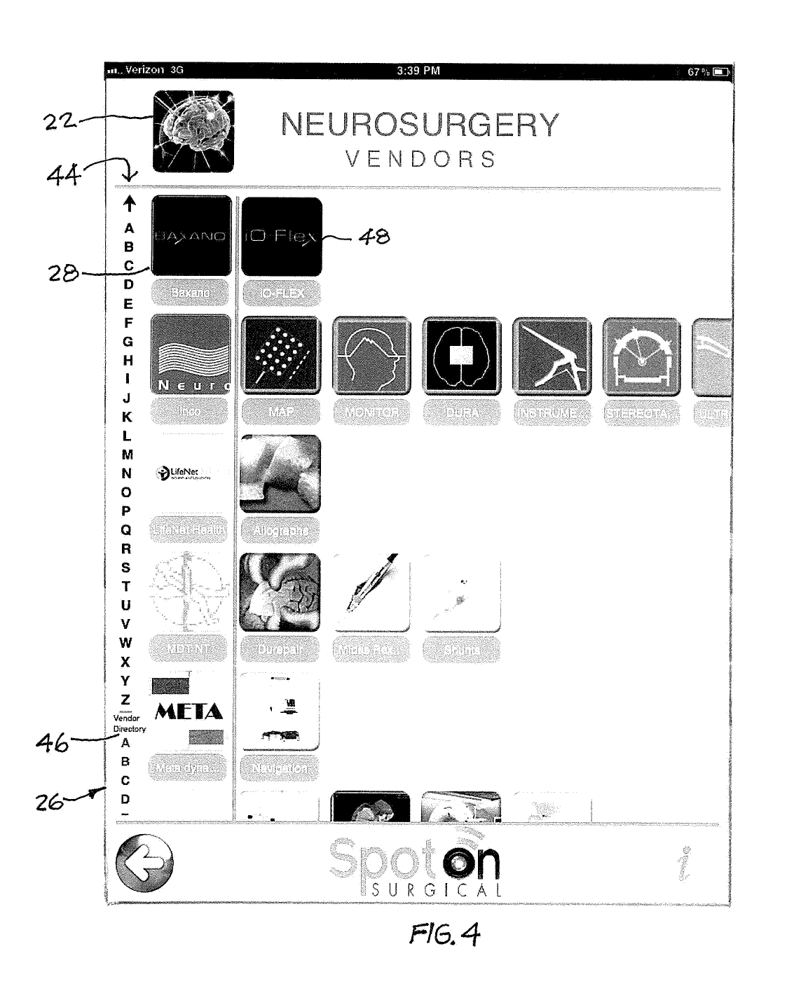

Considering now the use of embodiments of the invention, as shown in FIGS. 2 through 8, the customer service device 23 as shown in FIG. 2, provides a home page screen. Curated healthcare news is shown at the left of the Surgical specialty list on the right. Selecting a specialty such as button 20 launches the Specialty Vendor section as shown in FIG. 4. The top frame of this page opens a featured industry article with picture that is designed to entice the user to make the home page a regular visit and provide additional reasons to use the device.

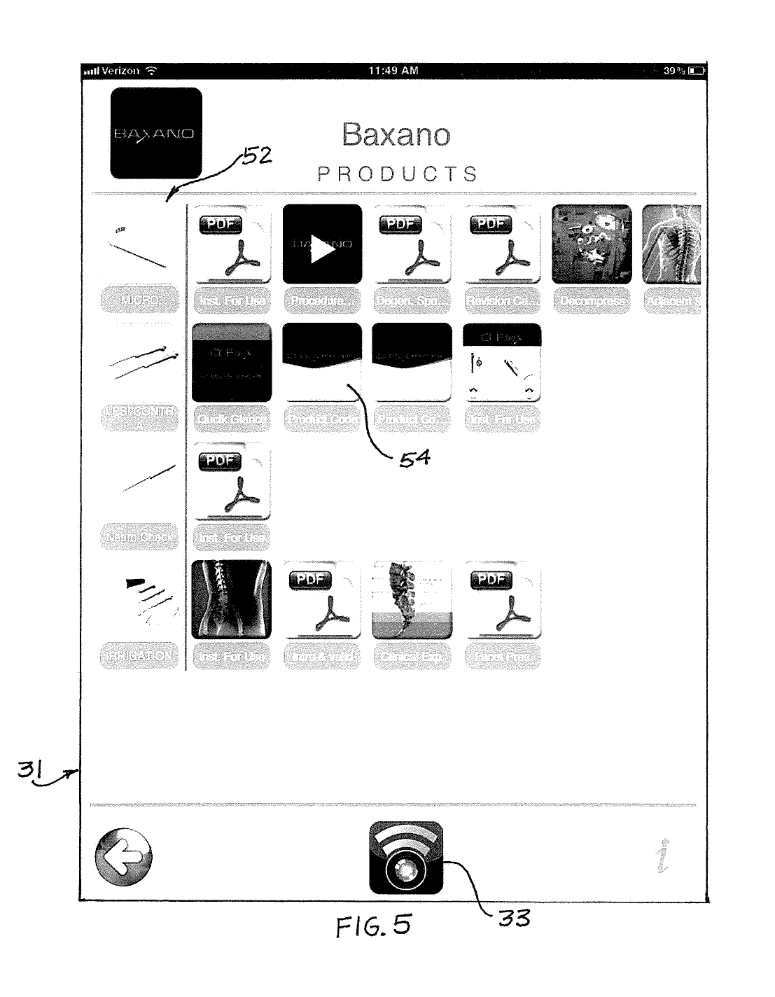

Neurosurgery Specialty Vendor page 26 is shown in FIG. 4. Alphabetical list of soft buttons in a left hand column at 44 of all participating vendors followed in the same column 44 by an alphabetical comprehensive vendor directory list 46 of all vendors to neurosurgery along with their phone number are displayed on page 26 thus providing a complete directory of vendors in the industry. Opposite each vendor, there is one or more soft buttons such as a soft button 48 for retrieving product information relating to a specific product and/or service provided by that vendor. By selecting a badge protected soft button 22, a premium content page 24 (FIG. 6) is generated. By selecting a company soft button such as button 28, a vendor page 31 (FIG. 5) is generated.

At this point the live support button 33 appears on page 31 and enables autodialing of the support desk or field personnel for that specific hospital. Content on the page 31 is arranged by product line and the vendor has password protected access to the SpotOn vendor portal to make additions or changes. In this regard, a product list of soft buttons in left hand column 52 are presented for this manufacturer/vendors for an email feedback loop related to that particular product. Opposite the column 52, is a list of soft buttons such as a soft button 54, for retrieving specific product information such as the product code associated with the button 54.

As shown in FIG. 6, behind each surgical specialty icon in the upper left hand corner of the specialty vendor page 26 is a collection of all Premium Content such as the premium content button indicated at 35 on page 24, that has been submitted by vendors. These advertorials are assembled as shown with a picture and capsule summary of the full content which can be opened full screen by tapping on them.

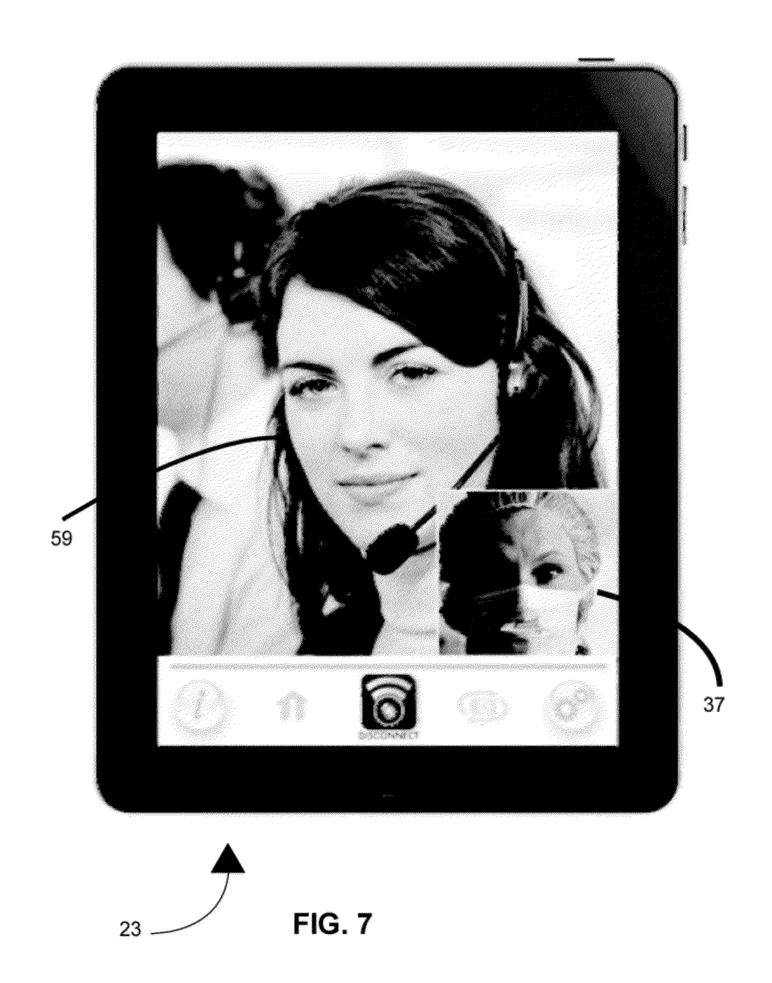

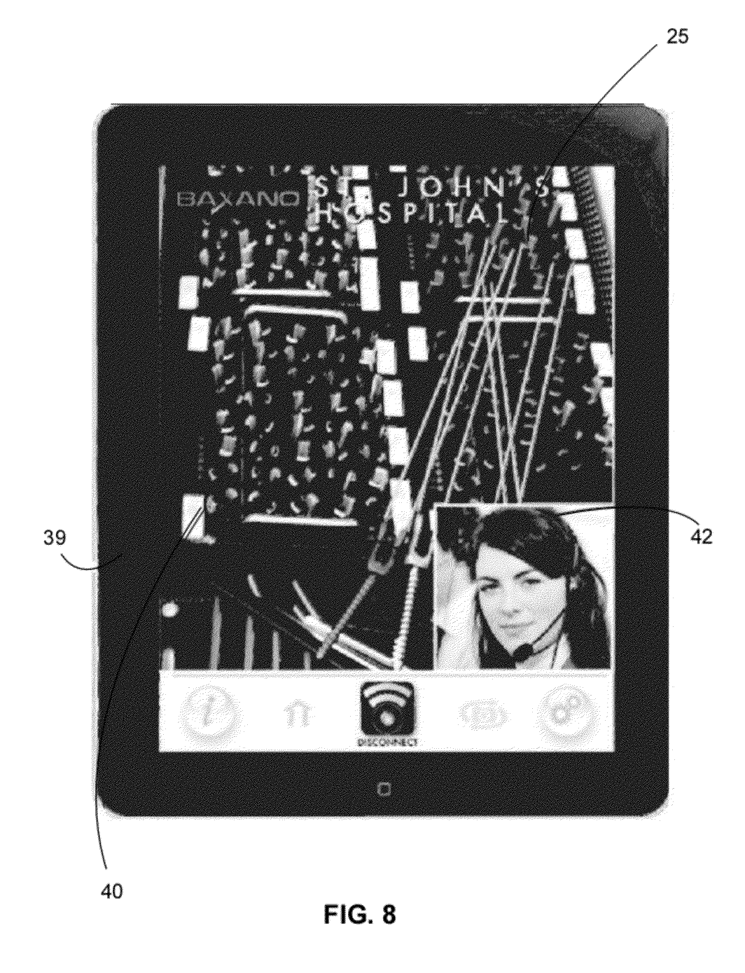

As shown in FIGS. 7 and 8, when the live support button 33 (FIG. 5) is pressed, a video call is placed to the appropriate vendor personnel (currently up to 4 people simultaneously) on their mobile devices or desktop computers such as the device 23. The vendor may choose to display their video (or take the “call” verbally without an outbound video image while accepting visual transmission from the initiating party), share photos, diagrams or other supportive documents. The OR personnel may display their face (FIG. 7) at 37 on their portable computer support device 23 used in the OR, or use the rear-facing camera to show, for example, OR equipment in use. As shown in FIG. 8, a vendor/manufacturer portable computer support device 39 communicates with the OR device 23 to receive an image 40 of the OR device in use. An image 42 of the vendor/manufacturer representative may be displayed as indicated at 59. In this manner, the representative can view an image of the equipment 25 being used in the OR, and thus make recommendations to the OR personnel.

Unlike other video over internet services, SpotOn Connect is initiated from wi-fi but can be directed to a wi-fi or cellular device. Also important is the fact that all video calls are initiated by the device in the OR. Calls cannot be made to the OR device from any outside party, even those vendor personnel that service the hospital.

This is a key feature. In order to avoid the initiator from not getting an answer and a visual response, the SpotOn Connect button calls multiple parties (defined by the vendor) simultaneously to assure a visual response and eliminate the need for the customer to have to potentially initiate several calls to multiple parties in order to get a response. MFT personnel may have the option of not accepting a video transmission from the OR when HIPAA compliance is an issue.

The following is a list of terms using herein:
Customer Support Device (CSD): a device which provides a portal for immediate direct verbal & visual communication between a customer in need of a service/support response at a given location and a service representative at another location. While this device is currently an iPad2, this device could evolve to another generation of the iPad or another device that provides comparable or enhanced capabilities.
SpotOn Content: The digital information provided by the MFTs for education and reference by the Customers.
SpotOn Connect: The smart dialing feature that enables customers to initiate an on demand visual interface with the MFT as hereinafter described in greater detail.
SpotOn Pad: The SOS owned CSD support. Another term for the CSD above.
Vendors/Manufacturers (MFT): Producers of items that benefit from a remote service and support solution for their products in their target marketplace.
Manufacturer Support Device (MSD): A desktop computer, laptop computer, smart phone, iTouch like device or an iPad or comparable tablet computer that can communicate verbal and visual direct interface to the CSD above.
Distributors (DIST): Agents that distribute and represent products of various manufacturers in a select geography.
Manufacturers Agents (AGENT): Sales agents that represent manufacturer products in a select geography, or direct manufacturer representatives.
Provider: Spot On Services (SOS)

The portal may provide immediate technical support tools for any product or service. In addition to the app itself, the system and method may have a web based portal that may be used by hospitals, vendors, reps and distributors to sign up to and customize their SpotOn experience, including but not limited to adding vendor content, defining rep territories, adding SpotOn participating vendors for access by distributors, vendors approving access by reps and distributors and other. A MFT interface may enable them to customize the support tools available to their customers on the CSD. Software may provide immediate, on demand live video interface between MFT, DIST, AGENTS and their customers as well as a reference tool for additional support materials from the MFT, including, but not limited to reference manuals, frequently asked questions, troubleshooting guides, teaching videos. The live video interface is always initiated by the customer. In this case, the operating room. This one way call restriction may be purposefully put in place to restrict the nature of the calls to customer support related issues and to eliminate the concern of the device becoming primarily a sales tool and distraction in an otherwise controlled environment.

On demand live video provides an enhanced customer experience due to:
Personal face to face visual creates an immediate relationship that enhances customer response and vendor reputation. There is no limit on the number that may be called out to, but only 3 may answer, i.e., no more than 4 may be in conversation simultaneously. If additional people try to join, they are placed in a “waiting room,” to be automatically promoted into the main room when someone leaves. Alternatively, they may receive a “room is full” message.
The room owner has a special privilege that they can always join. If there are 4 already, whoever came last is bumped out into a waiting room. In the hospital case, the OR room may be the owner. They may also have the privilege to Remove or Ban anyone.
Enhanced efficiency of direct visual interface when diagnosing a problem with a product or situation. Technology used by SOS provides the ability to have a macro and/or micro view to quickly address customer questions and issues
Visually addresses the problems created by language barriers. Many people have a difficult time conveying situations, describing items, listening to instruction, and the like, but these may all be overcome by visual communication.

Confidentiality may be addressed by means of a single password protected portal, a single support device (vs. multiple vendors providing their own support devices), SOS enterprise ownership and deployment of the iPads, control of the accessible (built in) apps, the security capabilities of current hardware vendor of choice (Apple), utilizing IP address designations at support sites, updates provided by a dedicated server with enhanced security provisions and encryption. The system may include, for example, Emergent, Apple and iVisit specifications. The system and method may also include the use of Mobile Device Management (MDM) third party software that also provides a separate level of security and provides additional capabilities including but not limited to the ability to set boundaries or fences to wipe the device remotely should it be stolen, control the use of native or third party apps, provide access to approved third party apps and more.

Suggested Uses of SOS are as follows:
to support a user who is unfamiliar with a product . . . or;
is an infrequent user of a product or device, particularly those requiring a high degree of user knowledge; or
when there is a time lapse between training and use of a device or product personnel turnover creates a need;
Competency of personnel on late shift or holiday staffing is lacking when there is a critical urgency for immediate support or when cost of delays or local support comes at a tremendous cost (i.e. Surgery);
on demand training on the use of a product;
reference tool for product information
when “expert eyes” and direct visualization is critical to resolving complex issues;
when customers are geographically difficult to support
when direct personal visits for support are not possible due to the size or staffing of the company; or
when an independent/unbiased single, centralized vehicle with a common interface is desired for customer support vs. multiple manufacturers with their own devices, policies and procedures for gaining access to their support capabilities.

### Interface:

The CSD (iPad or SD) may be each owned, managed and updated by SOS in order to maintain the integrity of the device and consistency of the appearance and operation.

The CSD (iPad or SD) units are custom configured as a support vehicle for a specific target customer. This would include identifying the built in software (i.e. on the typical iPad) that is applicable and available to the customer and also removing the ability of the customer to alter the device configuration in any manner.

A decision tree software which may reside on the server 36 and which efficiently directs the customer or user to the appropriate industry, business specialty and ultimately the precise company, product line and product they require support for.
The CSD is continually enhanced and updated with appropriate capabilities and market applications (apps) by the Provider
SOS owns the CSD. Each CSD may be updated by SOS via wi-fi or other network connection to the proprietary SOS server
Software and all updates are generated with an Enterprise Software Development Kit provided by the CSD manufacturer.

### Benefits:

The following is a list of at least some benefits:
MFTS, DIST, AGENTS (i.e. Medtronic Navigation)
Customers (i.e. Hospitals/Operating Room)
Benefactors (i.e. Surgeons)

### Levels of Service Provided by MFT to CSD:

MFT contracting SOS services may participate at a plurality of various service levels with a corresponding fee structure that is progressively more expensive depending on the capabilities desired. The appearance of MFT icons in the software interface may provide visual cues as to what services each MFT provides via SOS:

Basic alpha directory (home page display) provides the contact information for the MFT as well as other mft provided information related to it service access as it is available to SOS.

Reference (colored logo display): MFT, DIST AND AGENTS pay a fee to SOS to have a self directed area in the software for placing reference materials, including, but not limited to product support materials, reference manuals, frequently asked questions, troubleshooting guides, product listings, price lists, etc. Website links may also be available.

Video access (PLAY button>displayed in the product support material box): MFT may pay an enhanced fee over the above services for storage space beyond certain established storage limits related to video materials; including, but not limited to videos related to instructions for use, assembly, inservicing, etc.

Live Video (SpotOn Connect): MFT, DIST AND AGENTS pays a fee to access the CSD as a direct and immediate video link to live service and support as an adjunct for purely verbal communication. The connection button to “LIVE VIDEO SUPPORT” may be available on all of the MFT display pages.

Push Delivery of Premium Vendor Content (flag display on colored specialty logo indicating new information is available for customer viewing): MFT may pay an enhanced fee over the above services. This may provide immediate digital dissemination of appropriate support materials or information related to a MFT product to all customers that have a SD linked to the SOS Enterprise SDK Servers. New active MFT may also be identified via push notifications or via a NEW label on the active icon for the MFT.

### Compensation Structure

The following is a list of the fee structure:
Initial set up fee for customers (i.e. Hospitals) or MFTs requesting specialized support;
Customer (hospital) subscription fees which may provide the hardware (CSD), insurance for the device, MDM capabilities, updates of software and infrastructure related to the support program;
Fees for MFT based on the level of service access desired and the number of customers (hospitals) with accessible MSD that can access CSD in the marketplace;
Fees may be charged to distributors and their agents as well as any independent sales agents or direct MFT reps for each device that wishes to gain access to the CSD for sales support materials (SpotOn Content) or direct visual access to the customer via SpotOn Connect;
Advertorials may be provided by MFT, distributors and agents and delivered to CSDs for a fee via SOS SpotLight News and Premium vendor content; and
Targeted advertising.

### Direct Live Video:

The system and method may provide direct live video as follows:
All customers may have a CSD capable of live video calls via wi-fi;
Available to all MFT, distributors, agents, etc with wi-fi or cellular devices capable of live video calls;
SOS works with all new customers to assure that wi-fi transmission speeds are appropriate for uninterrupted & reliable video transmission; and
Customers linking to live video interface may be connected currently to any of up to 4 support personnel by a proprietary means of vendors assigning preferences for MFT support options (i.e. Customer service desk, local distributor office, local service or sales representative) then automatically dialing all customer support options to assure a live support experience and MSD that is immediately available.

### Feedback Mechanisms:

The following is a list of feedback mechanisms in the form of feedback software, which may reside on the server 36, and which may be provided by an embodiment of the system and method:

Metrics: SOS feedback software may enable measuring tools to determine the amount or frequency which selections (buttons) are chosen by the customer and thereby measure the frequency of:
Vendors being accessed
Length of the customer service episodes
Which service options provided by the MFT/vendor are being used most frequently
Frequency and duration of live video access requests
Effectiveness over time by comparison of tools used and length of service calls

### Customer Satisfaction Survey

Connection Timeliness
Overall experience
Service issue resolution
Suggestions to improve MFT service
Suggestions to improve SOS program

### Lead Generation

All customer solicitations for additional information, direct contact, quote may be directed to vendor with specific feedback down to an individual product. SOS may also have access to such feedback mechanisms to track the effectiveness of the SD to impact sales.

### Operation of Method and System

An Example of the use of the system and method in the Operating Room
6:30 A Circulating Nurse prepares for a 7:30 A cranial surgery by reviewing the pdf of the set up instructions for the placement of the camera and monitor for a posterior fossa surgery using a surgical navigation system.
   SpotOn: Nurse selects the surgical specialty (Neurosurgery) on the home page of the SupportPad>looks for the manufacturer (BrainLAB) and chooses the pdf showing equipment positioning instructions for various types of surgeries.
   Typically correct positioning would depend on the OR nurse having previous experience with this surgery. Complications come when such surgeries happen infrequently and operators are unfamiliar with the set up or the typical staff is not available to support the surgery. Incorrect placement would have required camera repositioning after the start of the surgery . . . causing delays, strong surgeon response, a disrupted surgery environment and a caustic exchange post op to the Operating Room Director.
8:00 A As the surgery begins, the circulating nurse uses the S(upport)Pad to pull up a video instruction to show a new nurse the video showing the instructions for preparing the tubing set that is used with the ultrasonic aspirator; another piece of equipment from another manufacturer that will be used later in the surgery.
   SpotOn: The nurse selects Neurosurgery on the home page>then manufacturer (Integra), then product>Ultrasonic Aspirator>then Model>then tubing set up instructions
   This previously would have required a nurse's dedicated time or perhaps would have resulted in a delay if the new nurse was expected to know the set up. A company representative (if available) would have to devote precious selling time to support the product the hospital purchased 3 years previously
9:45 A A spine procedure is starting in room 8. The surgical trays and back table are being prepared so all necessary instruments are accessible during the surgery. By pulling up the pictures that she has filed of the instrument sets that are loaned to the hospital for the surgery, she identifies the instruments needed in the bottom (invisible) trays and instructs the scrub (sterile nurse) where to find the instruments needed. The manufacturer representative arrives just before the surgeon needs the instruments.
   SpotOn: The nurse utilizes the filed pictures taken when the surgeon used the instruments for a previous surgery. Since that case did not go well . . . the nurse and surgeon discussed how the next case experience could be uneventful.
   No simple tool has been available to take or review appropriate pictures or aids to assure that the surgery preparation was perfect. SpotOn provides appropriate user tools to allow users to create site specific content that adds value to users at that particular hospital. This includes inherent tools that come with the device such as camera/video, photos, calendar, contacts, calculator, clock, voice memos as well as commonly available third party apps that compliment the support capabilities of the SupportPad such as Evernote as well as OR specific apps that are developed in the future which use SpotOn as the vehicle for users to access the app.
11 A The specialty nurse for ENT has called in sick. The upcoming surgery is for a sinus revision and the staff is scrambling to get the video equipment and the navigation system into proper position. The nurse has not used a sinus debrider for months and does not recall how to exchange the curved and straight attachments.
   SpotOn: The nurse does not have time to research the support tools provided by the manufacturer and chooses the live support soft button to get immediate face to face video assistance. The system calls all available MFT support personnel that have been authorized to support the hospital. A customer support person from the corporate office answers, but is dismissed from the visual conference when the local representative also joins the conference. The representative answers the nurse's questions then while the camera has a direct view into the room, the representative expresses concern that the camera for the navigation system should be placed at the head of the surgical table.
   Without expert “eyes in the room”, the situation could disintegrate due to improper placement of the camera and the nurse circulators in the room would be scrambling to find the curved attachment for the debrider. A nerve racking disaster would ensue.
12:30 The cardiovascular specialty nurse is coordinating the instruments for the next days surgery.
   SpotOn: To assure that everything is ready for the surgeon, the nurse reviews the surgeon's preference list that he or she prepared in a third party application on the SupportPad portable computer. She then uses the contact list embedded in the standard device software to pull up the surgeons name and text a note.
   The surgeon responds to the text and the nurse realizes that the proper instruments are not at the hospital. She calls the local representative to make arrangements for the loaner instruments to be delivered.
   Disaster and perhaps a case delay or cancellation is avoided. The case goes on time, a delay is avoided and a costly cancellation saves the hospital money and the patient an extra day in the hospital.
2:00 P There is another cranial surgery taking place in room 5 using the Medtronic Stealth Navigation System. All OR personnel supporting the surgery are familiar with the system, yet suddenly the system navigation probe does not seem to be working.
   SpotOn: The nurse goes to the proper link in on the SupportPad that provides a troubleshooting guide.
   He or she instructs the surgeon to look at the reflective spheres on the navigation tool to see if there is blood on any of the spheres. The blood is causing the camera to not see the full dimensions of the sphere and is rendering the tool useless. The instructions call for the blood to be wiped off and then dried. The system immediate resumes its ability to navigate and the surgery proceeds uninterrupted.
   This somewhat frequent occurrence is seldom diagnosed properly by operating room personnel. Additionally, the benefits of surgical navigation may be abandoned so the surgery can proceed without the use of the equipment. The surgeon and the support personnel in the room are frustrated, the patient doesn't gain the benefits of the technology and the manufacturers representative is called in to determine why the system failed. After investing a couple of hours trying to find a technical problem that didn't exist, he commits to “babysitting” the equipment during next surgery to make sure that he is there if the problem persists. Additional hours of valuable selling time are wasted in an attempt to avoid surgeon wrath against his products.
3:30 P The PM OR nursing staff has arrived, but the nurse preparing for a 5:00 p.m. surgery has never balanced the operating microscope.
   SpotOn: The nurse chooses the specialty (neurosurgery), then the Manufacturer of the microscope (Leica the hospital launches SpotOn Connect to access immediate visual assistance. The local representative receives the notification on his cell phone, but is driving and elects to let other company support personnel answer the call from the operating room. After connecting the support person instructs the nurse to position the SupportPad so he can view the equipment and instruct the nurse in the proper set up and balancing for the upcoming case. The manufacturer makes note to add a video inservice to the MFT SupportPad page for future calls regarding balancing.
   The scope is perfectly prepared and the surgery proceeds without event. The manufacturer support person uses the event to suggest addition of a new support tool for their site that will assist customers and also free up personnel in the future by providing a self directed learning video on “How to Balance the Leica Microscope”.
7:30 P Things are becoming out of control in room 12. The surgeon is insisting that a technical representative be called immediately to make their way to the hospital as fast as possible. How can nobody know how to use the drill system when he has been using it for the past 8 years.
   The nurse calls on the phone to the local representative and leaves a message when prompted by voicemail. After a 20 minutes wait, the impatient surgeon screams for immediate action. The anxiety in the room intensifies and the nurse calls the specialty nurse coordinator at home.
   SpotOn: She instructs the nurse to find the iPad. She selects>ortho>then the Manufacturer (Midas Rex)>then SpotOn Connect.
   The support representative appears on the iPad and instructs the nurse to touch the reverse camera icon to activate the front facing camera. The support representative asks to be introduced to the surgeon. He or she quickly diffuses the tension and asks that the nurse provide a direct view of the surgical tray for the drill system. He or she quickly identifies the attachment that the surgeon is requesting and then instructs the nurse to reverse the camera back to a face to face view. He or she walks the scrub nurse through the process to fit the proper attachment to the drill by demonstrating it with a similar instrument he or she uses for demonstration. The surgeon confirms that the problem has been addressed and expresses his or her appreciation.
   Without direct visualization, this situation may have to be resolved by verbally describing what the attachment looked like and attempt to verbally walk the nurse through the process of fitting the new attachment to the drill handle. The verbal exchange may likely have been difficult due to language difficulties or the nurses unfamiliarity with the product.

The following is a list of certain advantages and features of the system 10:

1) There could be a proprietary means of customer or user prioritization of contacts and an automatically cycling through these choices or whether there would be a single contact at the vendor end with conferencing options to add or transfer to other people.

2) vendors may be able to push notices to all users.

3) a permanent grouping of soft buttons at the bottom of each window that may provide immediate access to SOS related material. This would include, but not necessarily be limited to:
a) summary of mft push information by specialty
b) an RSS feed of timely curated industry and/or specialty related information that would encourage daily use (home page)
c) a curated news capsule with picture (home page) that could be opened to view full content. This is also to encourage daily use.
d) a link to the SpotOn website for access to company information, accessories store, direct feedback to SpotOn, users stories, suggestions, photo submissions, and other.
e) link to native CSD tools that are approved for access by SpotOn and inherently available with the device including but not limited to CALENDAR, CONTACTS and CAMERA/VIDEO.
f) link to other SpotOn approved third party applications that may be made available to the CSDs including but not limited to broadband connection speed measurement tools, education materials or any other application based software that supports the SpotOn model.

4) the system may be used also for other applications such as for technical guidance in the use of a variety of other products.

5) An application that may be exclusively for the representatives in the field (vs. at the MFT location) to be able to receive customer LIVE requests, yet this may not provide the ability to initiate a video connection with the device. This rep app may also house sales (vs. support) and any other MFT content that would be appropriate to support sales and customer service. A distributor app may be available which serves a similar role to the rep app above, but also provides the ability to have the content from several MFTs that approve access of their content by the DIST.

6) a conferencing capable video application within an SOS application that may also enable advanced photographic features such as photo sharing and zoom/shrink/panning tools to complement the customer interface and facilitate understanding and efficient resolution of the customer's issue.

7) at least some of the information on the CSD may reside in memory therein, particularly broadband intensive content like video that could potentially bog down transmission speed of the SOS server and affect all users.

8) all of the features of the application may be provided to all vendors since the LIVE capability is the main feature to draw prospects to the service.

9) a robust feedback mechanism may be used to receive customer insights, suggestions, comments, and requests (i.e., have a representative call, send me more info, not interested, etc.) They can give feedback on SOS, mft performance, Request info, etc.

10) the system 10 may include an application for field reps to download. This is important for HIPAA compliance confirmation and as a revenue stream that appropriately scales investment size with the size of the company and number of target customers that fit a market profile. It also allows independent distributors to participate and could defray some of the costs of SOS away from the manufacturer.

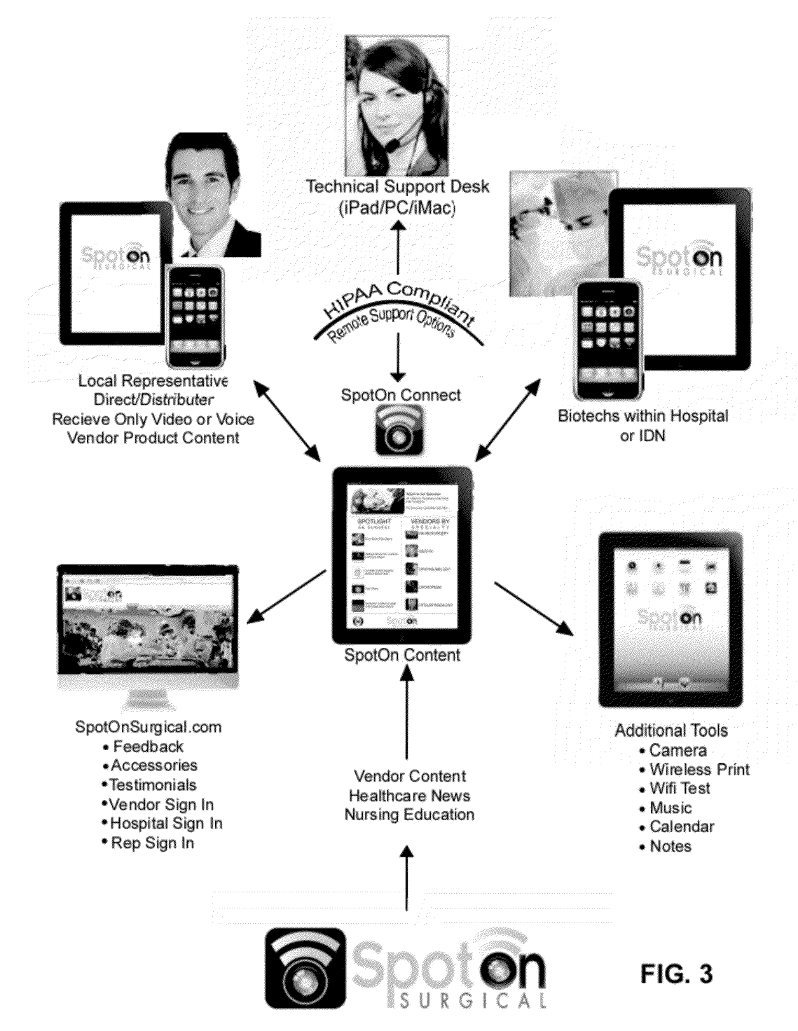

Referring now to FIG. 3, there is shown a layout of various presently contemplated features of the system 10, to provide a variety of features for presentation to the user on the display device 23. The following is a list of at least some of the features which may be incorporated in system 10:

Specialty Listing: Using standard application layout for the specialties, to include a search feature in the future. SOS offering may be at the bottom of page.

Vendor Listing: This page may have participating SpotOn vendors with vendor customized icons and content as well as an alphabetical listing of SpotOff vendors that have not contracted with SpotOn and only have their basic customer service access information available. SOS offering may be at the bottom of the page.

This may be an email or text choice plus directions for manufacturer/vendor follow up. May be same as feedback loop for SOS. Email to feedback information at SpotOnSurgical.com

By Product Line Category: For broad product offerings similar to Medtronic or Integra. This choice may lead to the specific product link above.

May always be available by touching the Product soft button or the MFT icon on the product page.

Push Notifications: May include link to feedback form that may be directed to the vendor and SOS for compiling, tracking response, metrics tracking, and other.

SOS Options: May reside at the bottom of each page after the opening Splash.

SPOT News & Information: Curated RSS news feed format with featured vendors may be arranged by specification, picture of the day, suggestions, creative uses, application review, customer stories, and other.

Spot Live: This feature may provide an interface with SOS. This is an important feature for assistance in navigating the tool and providing direct feedback. This may also be a feature to provide initially during software improvements and eliminate once system is trouble free. Further feedback to SOS may be through email only.

Spot by Spec: RSS feeds may be provided by specialty in format with feedback loop.

Spot Push by Specialty: Confidential product information may be directed from manufacturers/vendors to customer contacts.

The following is a partial list of at least some of the features of certain embodiments of the present invention:
Metrics
Surgeon Application
This may contain the premium MFT information provided for each surgical specialty. It may also contain an RSS feature for that particular specialty, connection via text or visually to approved parties, third party applications and more.
One button multi party SpotOn Connect dialing feature
iPad lockdown, levels of access, MDM software
Security and specs
tagging content for written or verbal search capability
Picture sharing with zoom/shrink capability
Third party application vehicle: Common (Evernote) and industry specific (OneSource)
Return to application feature
The system and method control the user experience and keep it consistent. Many manufacturers have already developed apps which may be able to embed within the SpotOn app. They can access them by pushing the appropriate soft button to access the app in an identical way to accessing a video, doc or any other digital content provided by the MFT. Once finished using the app, the user may be returned to the SpotOn page that initiated the MFT app.
Links to vendor pages with restricted access to internet and return to application feature
Adding hospital biotech or MD to SO Connect feature
Bluetooth connection to Bluetooth speakers and headphones & printers or any other Bluetooth enabled device that benefits the SpotOn model.
Coding system to match vendor content to company approved, HIPAA compliant representatives
Independent, unbiased third party linking OR personnel to vendor content and virtual presence
Fee structure: Subscription
   Hospital: may include insurance and MDM
   Vendor access
   Support Apps with SO Content and Connect:
      Customer Service
      Direct representative, MFT representative
      Distributor application
Randomized landing for the specialty vendor listing to assure equal access to initial vendor product impressions
Use of Tools: i.e., ability of users to create custom reference materials for their site such as pictures/videos, documents, forms that can be filed for future reference
Back end database and portal
iVisit room configures, picture sharing, zoom/pinch, auto deletion. Hospital saving to picture file (Evernote)
Ability to track redirects to vendor sites (i.e., Medtronic). Third party Pay sites such as OneSource would pay SO a fee to place their application on the SupportPad or perhaps an access fee to place their content on the SupportPad and a password protected access door to their website
Viral selling dynamic: All customers sell the benefits of the SpotOn model: Hospitals to vendors and representatives, representatives, agents and distributors to vendors, vendors to hospitals, surgeons to hospital/representatives/vendors
Search capabilities: MFTs may provide tags to the product information that would enable the user to search for specific product with a search term. This could be done via typed entry or voice command.

While particular embodiments of the present invention have been disclosed, it is to be understood that various different modifications and combinations are possible and are contemplated within the true spirit and scope of the disclosed embodiments. There is no intention, therefore, of limitations to the exact disclosure herein presented.

What is claimed is:

1. A system for facilitating technical support of equipment at multiple different geographical equipment locations by a number of different MFTs at still different geographical locations, comprising:
a central portal having a server;
portable computers/tablets for use at equipment location by equipment users to facilitate technical support;
vendor/manufacturer representative computers/tablets/smart phones for communicating with the portable computers/tablets;
the portal (server) serving as a gateway to complete the electronic establishment of communications between the portable computers and representative MSDs so that substantially all communications between portable computers and MSDs are established through the portal;
the portable computers each having soft buttons individually associated with vendors; and
wherein the soft buttons are activated selectively on the portable computers to call the portal to complete the establishment of communication between the portable computers and selected representative MSDs.

2. A method of facilitating technical support of equipment at multiple different equipment locations by a number of different vendors at still different geographic locations, comprising:
using portable computers at equipment locations by equipment users to facilitate technical support;
completing by means of a portal the electronic establishment of communications between the portable computers and representative MSDs so that substantially all communications between portable computers and MSDs are established through the portal; and
activating soft buttons of the portable computers individually associated with MFTs to call the portal to complete the establishment of communication between the portable computers and selected MSDs.

3. A method according to claim 2, further including pushing messages for at least one MSD for distribution therefrom to the portable computer.

4. A method according to claim 3, further including sending the messages from the at least one MSD to the portal.

5. A method according to claim 4, further including using the portal to upload information to each one of the MSDs to create new soft buttons for the MSDs.

6. A method according to claim 5, further including determining the first available MSD by using the portal.

7. A method according to claim 6, wherein the portal enables the first available representative MSD to be determined by using an approved caller/recipient data base module.

8. A method according to claim 7, further including directing a user to an appropriate product for support purposes using a decision tree software.

9. A method according to claim 8, further including providing a plurality of levels of service.

10. A method according to claim 9, further including providing live video calls via the portal to the portable computers.

11. A method according to claim 10, further including determining the amount or frequency of the user of the soft buttons using a feedback software.

12. A method according to claim 11, further including providing user prioritization.

13. A method according to claim 12, further including providing photographic features.

14. A method according to claim 13, further including implementing a cost model.

15. A method according to claim 14, further including employing a search function.
